(19) United States
(12) Patent Application Publication
(10) Pub. No.: US 2011/0261171 A1
(43) Pub. Date: Oct. 27, 2011

(54) VIDEO PROCESSING APPARATUS

(76) Inventors: Satoshi OTSUKA, Yokohama (JP); Hidenori Sakaniwa, Yokohama (JP); Sadao Tsuruga, Yokohama (JP)

(21) Appl. No.: 13/090,428

(22) Filed: Apr. 20, 2011

(30) Foreign Application Priority Data
Apr. 21, 2010 (JP) 2010-097500

(51) Int. Cl. H04N 13/04; H04N 5/93

(52) U.S. Cl. 348/51; 386/353; 348/E13.075; 386/E05.028

(57) ABSTRACT

A video processing apparatus comprises an input unit, to which video information is inputted; a decoder unit, which is configured to decode the video information inputted to the input unit; and an output unit, which is configured to output the video information decoded within the decoder unit, wherein a message indicting that there is a schedule for outputting 3D video information from the output unit, in case where the video information to be inputted to the input unit after elapsing a predetermined time is the 3D video information, or the video information outputted from the output unit is 3D video information, and a message for prompting a user to be in a condition of being able to view the 3D video from the output unit, if the user is not in the condition of being able to view the 3D video, or the video information outputted from the output unit is 3D video information, and an output of the 3D video information from the output unit is stopped, temporally, when the user is not in the condition of being able to view the 3D video. Or, it further comprises a recording unit, which is configured to record the video information inputted to the input unit onto a recording medium, wherein the recording unit starts recording of the 3D video information, when the 3D video information is inputted to the input unit in case where a user is not in a condition of being able to view the 3D video.

This application relates to and claims priority from Japanese Patent Application No. 2010-097500 filed on Apr. 21, 2010, the entire disclosure of which is incorporated herein by reference.

### BACKGROUND OF THE INVENTION

The technical field relates to digital content for executing a 3D (Three dimension: hereinafter, “3D”) video display.

In the following Patent Document 1, while pointing out “in case where a user could not watch because of any reason, or did not make a reservation of that program, she/he cannot make the reservation and looses a change of watching that program” (see paragraph [0004] of the Patent Document 1), as the problem(s) to be dissolved, there is described, as the means for dissolving thereof, “comprising a clock circuit for measuring time, and a memory for memorizing program data, including a channel of a broadcast program, through which transmission was made by a predetermined number of times, and a starting time of the broadcast therein, as program data, within at least one of a television receiver and a television broadcast signal recording/reproducing apparatus, and a control circuit for controlling said television broadcast signal recording/reproducing apparatus to execute recording of that broadcast program, when the time measured by said clock circuit is coincident with the starting time of broadcasting of the desired program data at desire, which is memorized in said memory, and also when both said television receiver and the television broadcast signal recording/reproducing apparatus did not receive the broadcast program, which is indicated by said desired program data (see paragraph [0006] of the Patent Document 1).

Also, in the following Patent Document 2, while pointing out “to provide a digital broadcast receiving apparatus for enabling to give a notice, actively, that a program that a user wishes to watch will start on a certain channel, etc.” (see paragraph of the Patent Document 2), as the problem(s) to be dissolved, there is described, as the means for dissolving thereof, “comprising a means for taking out the program information included in a digital broadcast wave, and for selecting a notice target program with using the selection information, which is registered by the user, and a means for displaying a message of noticing a presence of the notice target program selected, pushing it on a screen, being displayed at present” (see paragraph [0006] of the Patent Document 2).

### PRIOR ART DOCUMENTS

### Patent Documents

[Patent Document 1] Japanese Patent Laid-Open No. Hei 5-2794 (1993); and
[Patent Document 2] Japanese Patent Laid-Open No. 2003-9033 (2003).

### BRIEF SUMMARY OF THE INVENTION

However, in the Patent Documents 1 and 2, there is no disclosure relating to viewing/listening of 3D content. For that reason, in relation to the viewing/listening of the 3D content, if display of the 3D content is started under the condition where a user is not ready for viewing/listening the 3D content, then the user cannot view/listen that content under the best condition; there is a possibility of losing convenience for the user.

For dissolving such problem(s) mentioned above, according to one embodiment of the present invention, there is provided a

According to such means mentioned above, it is possible to increase the convenience for the user, in relation to the viewing/listening of the 3D content.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an example of a system configuration;

FIG. 2 shows an example of the structure of a transmitting apparatus;

FIG. 3 shows an example of the structure of a receiving apparatus;

FIG. 4 shows an example of function blocks within the receiving apparatus;

FIG. 5 shows an example of a 3D encoding descriptor;

FIG. 6 shows an example of a flowchart of a system controller unit;

FIG. 7 shows an example of a message display;

FIG. 8 shows an example of the message display;

FIG. 9 shows an example of the message display;

FIG. 10 shows an example of the message display;

FIG. 11 shows an example of a flowchart of the system controller unit, when a next program starts;

FIG. 12 shows an example of the message display;

FIG. 13 shows an example of the message display;

FIG. 14 shows an example of a flowchart of the system controller unit, before the next program starts;

FIG. 15 shows an example of a flowchart of the system controller unit, after the next program starts;

FIG. 16 shows an example of the message display;

FIG. 17 shows an example of a flowchart of the system controller unit, after a user selects;

FIG. 18 shows an example of the message display;

FIG. 19 shows an example of a flowchart of the system controller unit, after the user makes selection;

FIG. 20 shows an example of a flowchart of the system controller unit, after a program starts;

FIG. 21 shows an example of the message display;

FIG. 22 shows an example of a flowchart of the system controller unit, after the program starts;

FIG. 23 shows an example of a flowchart of the system controller unit, after the program starts;

FIG. 24 shows an example of a flowchart of the system controller unit, after the user makes selection;

FIG. 25 shows an example of a flowchart of the system controller unit, after the program starts; and

FIG. 26 shows an example of a flowchart of the system controller unit, after the user makes selection.

### DETAILED DESCRIPTION OF THE PREFERRED EMBODIMENTS

Hereinafter, examples (embodiments) according to the present invention will be fully explained by referring to the attached drawings. However, the present invention should not be restricted to the present embodiments. For example, the present embodiments are explained about a digital broadcast receiving apparatus, and are suitable to be applied into a digital broadcast receiving apparatus; however, should not be prevented from being applied into those other than the digital broadcast receiving apparatus. All of the constituent elements of the embodiments are not necessary to be adopted therein, but can be selected, optionally.

### <System>

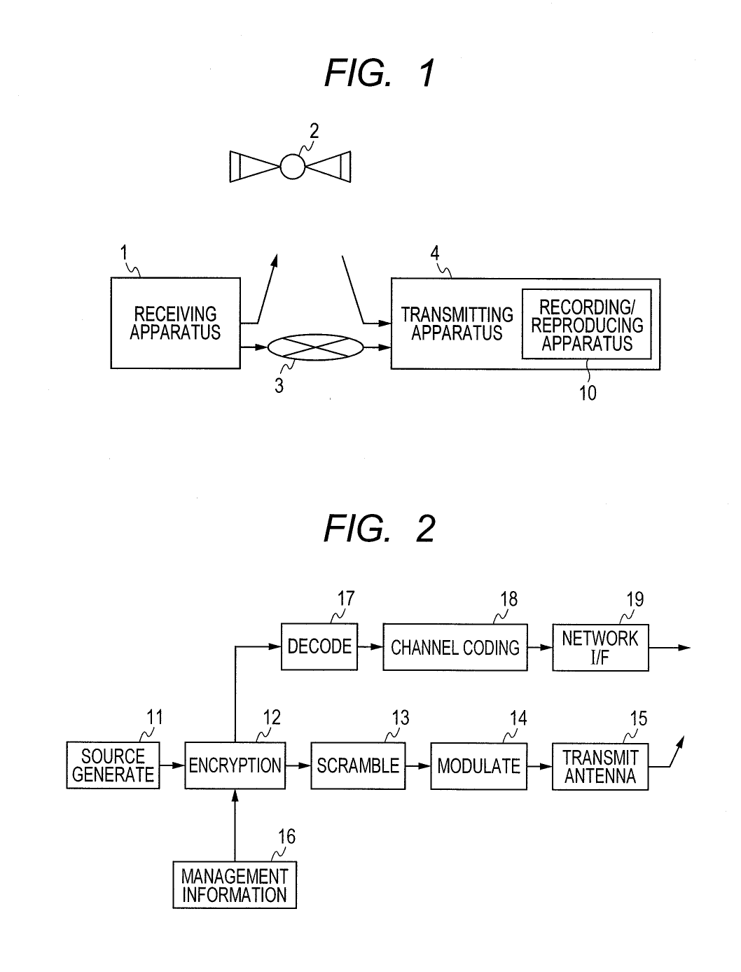

FIG. 1 is a block diagram for showing an example of the structure of a system, according to a present embodiment. Thus, there is shown a case where information is transmitted/received through a broadcasting, to be recorded/reproduced, as an example. However, it should not be limited to the broadcasting, and may be VOD by means of communication, wherein they are also called “distribution”, collectively.

A reference numeral 1 depicts a transmitting apparatus, which is installed in an information providing station, such as, a broadcast station, etc., for example, 2 a relay apparatus, which is installed in a relay station or a satellite for use of broadcasting, etc., 3 a public circuit network for connecting between an ordinary household and a broadcast station, such as, the Internet, etc., 4 a receiving apparatus installed within a house of a user, and 10 a receiving recording/reproducing apparatus, respectively. In the receiving recording/reproducing apparatus 10, information broadcasted can be recorded or reproduced, or content from a removable external medium can be reproduced, etc.

The transmitting apparatus 1 transmits a modulated signal wave through the relay apparatus 2. It is also possible to apply therein, such as, transmission by means of a cable, transmission by means of a telephone line, terrestrial broadcast, an Internet broadcast through the public circuit network 3, etc., for example. This signal wave received by the receiving apparatus 4, as will be mentioned later, after being demodulated into an information signal, it is recorded onto a recording medium depending on necessity thereof. Or, in case where it is be transmitted through the public circuit network 3, it is converted into a data format (i.e., IP packet), in accordance with a protocol suitable for the public circuit network 3 (for example, TCP/IP), etc., while the receiving apparatus 4 receiving that data decodes it into the information signal, to be recorded onto the recording medium depending on necessity thereof. Also, the user can view/listen video/audio, which are shown by the information signal, on that display in case where the receiving apparatus 4 has a built-in display, or through connecting a display with it.

### <Transmitting Apparatus>

FIG. 2 is a block diagram for showing an example of the structure of the transmitting apparatus 1, within the system shown in FIG. 1.

A reference numeral 11 depicts a source generator unit, 12 an encoder unit, for executing compression through a MPEG method, etc., and also adding program information, etc., 13 a scrambler unit, 14 a modulator unit, 15 a transmission antenna, and 16 a management information conferrer unit, respectively. Information, such as, video/audio generated in the source generator unit 11, which is constructed with a camera, a recording apparatus, etc., is treated with compression of data volume thereof, within the encoder unit 12, so as to be transmitted with an occupation of less bandwidth. Depending on necessity thereof, it is encoded within the scrambler unit 13, in such a manner that a specific viewer can view/listen it, and is transmitted. After being modulated to be a signal suitable for transmission within the modulator unit 14, it is transmitted as radio wave, from the transmission antenna 15, directing to the relay apparatus 2. In this instance, within the management information conferrer unit 16, it is added with program identify information, such as, a property of content, which is produced in the source generator unit 11 (for example, encoded information of video and/or audio, encoded information of audio, structure of program, 3D picture or not, etc.), or program arrangement information produced by the broadcast station (for example, structure(s) of a present program and/or a next program, a format of service, structural information of programs for one (1) week, etc.), or the like. Those of the program identify information and the program arrangement information will be called, collectively, “program information”, hereinafter.

Further, in many cases, plural numbers of information are multiplexed on one radio wave, through a method of, such as, time-sharing or spread spectrum, etc. Although not shown in FIG. 2 for the purpose of simplification, but in this case, there are provided plural numbers of systems, each including the source generator unit 11 and the encoder unit 12 therein, and wherein a multiplexer unit (or multiplexing unit) for multiplexing plural numbers of information is disposed between the encoder unit 12 and the scrambler unit 13.

Also, with respect to the signal transmitted through the public circuit network 3, in the similar manner, the signal produced in the encoder unit 12 is encrypted within an encryption unit 17, depending on necessity thereof, so that it can be viewed/listened for a specific viewer. After being encoded to be a signal suitable for transmission through the public circuit network 3 within a communication path or channel encoder unit 18, it is transmitted from a network I/F (Interface) 19, directing to the public circuit network 3.

### <Hardware Structure of Receiving Apparatus>

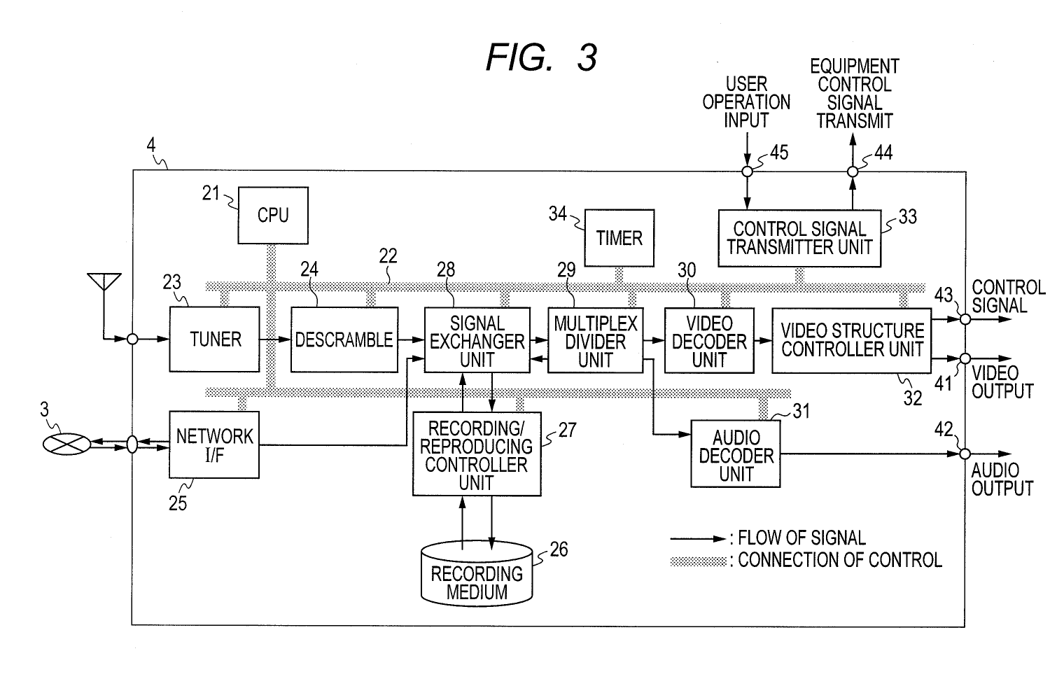

FIG. 3 is a hardware structure view for showing an example of the structure of the receiving apparatus 4, within the system shown in FIG. 1. A reference numeral 21 depicts a CPU (Central Processing Unit) for controlling the entire of the receiver, 22 a common bus for transmitting control and information between the CPU 21 and each portion within the receiving apparatus, 23 a tuner for receiving the broadcast signal transmitted from the transmitting apparatus 1 through a broadcast transmission network, such as, a radio (satellite, terrestrial), a cable, etc., for tuning a specific frequency, for executing demodulation, error correction processing, etc., and thereby outputting a multiplex packet, such as, MPEG2 Transport Stream (hereinafter, may be called “TS”, too) therefrom, 24 a descrambler for decoding or dissolving scramble, which is made by the scrambler unit 13, 25 a network I/F (Interface) for transmitting/receiving various kinds or categories of information and the TS between the Internet and the receiving apparatus, 26 a recording medium, such as, a HDD (Hard Disk Drive) or a flash memory, which is provided within the receiving apparatus 4, for example, or a removable HDD, or a removable disc-type recording medium, or a removable flash memory, etc., 27 a recording/reproducing controller apparatus for controlling the recording medium 26, thereby controlling recording of the signal onto the recording medium 26 and/or reproduction of the signal from the recording medium 26, 28 a signal exchanger device for exchanging an input signal from the descrambler 24, the network I/F 25 and the recording/reproducing controller apparatus 27 above-mentioned, and thereby outputting it to a multiplex dividing apparatus 29 or the recording/reproducing controller apparatus 27, and 29 the multiplex dividing apparatus for dividing the signal, which is multiplexed into a format of TS, etc., into signals, such as, a video ES (elementary stream), an audio ES, the program information, etc., respectively. The ES means the video/audio data, each of which is compressed/encoded, respectively. A reference numeral 30 depicts a video decoding apparatus for decoding the video ES into a video signal, 31 an audio decoding apparatus for decoding the audio ES into an audio signal, thereby outputting it from an audio output 42, 32 a screen structure controlling apparatus for controlling the structure of a screen, for example, superimposing a display of OSD (On Screen Display) or the like, which is produced by the CPU 21, on the video signal received from the video decoding apparatus 30, thereby outputting the video signal and a sync signal and/or a control signal (to be applied into the control of the equipments) from a video signal output unit 41 and a control signal output unit 43, 33 a control signal transmitting/receiving unit for receiving an operation input (for example, a key code from a remote controller for generating an IR (infrared radiation) signal) from a user operation input unit 45 and also for transmitting an equipment control signal (for example, IR) to an external equipment, which is produced by the CPU 21 or the screen structure controlling apparatus 32, from an equipment control signal transmitter unit 44, and 34 a timer having a counter in an inside thereof and for maintaining the present time therein, respectively, wherein the receiving apparatus 4 is mainly constructed with those apparatuses, units and/or devices, etc. Further, in the place of the video signal output unit 41 or in addition thereto, there may be provided a 3D video display, thereby for displaying the video or picture decoded by the video decoding apparatus 30 on that 3D video display. Also, in the place of the audio output 42 or in addition thereto, there may be provided a speaker(s), thereby for outputting sounds upon basis of the audio signal, which is decoded by the audio decoding apparatus, from that speaker(s). In this case, the receiving apparatus 4 comes to be a 3D video displaying apparatus. Even in case where the display is made on a 3D video display, if necessary, the sync signal and the control signal are outputted from the control signal output unit 43 and the equipment control signal transmitter unit 44.

However, a part of each of the constituent elements 21 through 34 shown in FIG. 3 may be constructed with one (1) or plural numbers of LSIs. Or, a part of functions of each of the constituent elements 21 through 34 shown in FIG. 3 may be constructed with software.

### <Function Block Diagram of Receiving Apparatus>

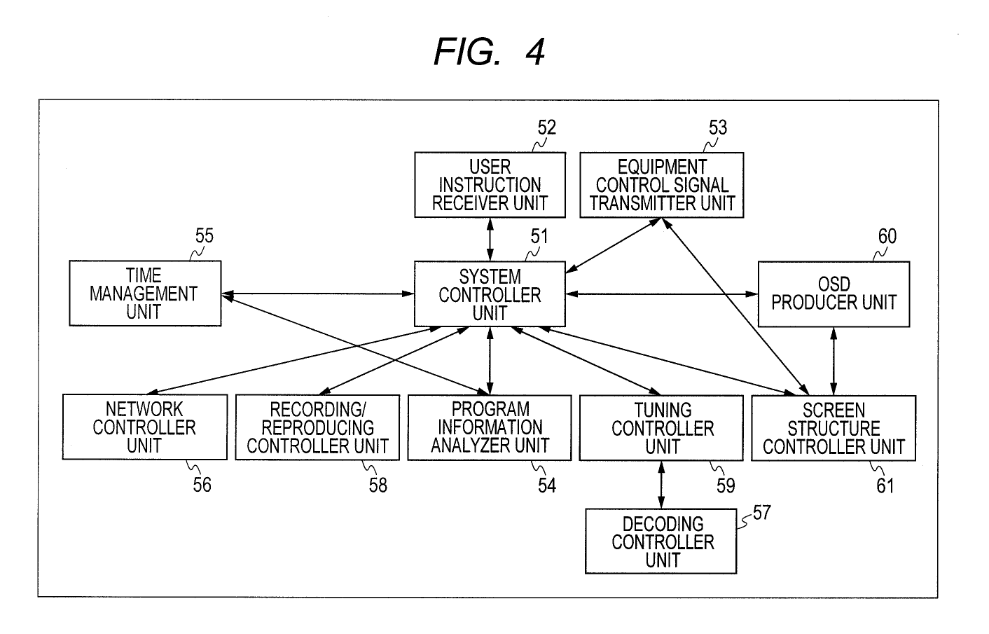

FIG. 4 shows an example of a function block structure of the processes in an inside of the CPU 21. Herein, each function block exists, for example, in the form of a module of the software to be executed by the CPU 21, wherein a delivery of information and/or data and an instruction of control is/are done, by executing an any kind of means (for example, a message passing, a function call, an event transmission, etc.) between the modules, respectively.

Also, each module, as well as, each hardware in the inside of the receiving apparatus 4, executes transmission/reception of information through the common bus 22. Also, through relation lines (arrows) are shown mainly for the parts relating to the explanation, which will be explained at this time; however, between other modules, there is/are also exist(s) a process(es), which necessitate(s) a communication means and communication. For example, a tuner controller unit 59 obtains the program information necessary for tuning, appropriately, from a program information analyzer unit 54.

Next, explanation will be given about each function block. A system controller unit 51 manages a condition of each module and/or an instruction condition of a user, etc., and thereby executes a control instruction for each module. A user instruction receiver unit 52, receiving and interpreting an input signal of the user operation, which is received by the control signal transmitting/receiving unit 33, transmits the instruction, which is made by the user, to the system controller unit 51. An equipment control signal transmitter unit 53, in accordance with an instruction from the system controller unit 51 or other module, instructs the control signal transmitting/receiving unit 33 to transmit an equipment control signal therefrom.

The program information analyzer unit 54 obtains the program information from the multiplex dividing apparatus 29, to analyze it, and thereby provides the necessary information for each module. A time manager unit 55 obtains time correction information (i.e., TOT: Time Offset Table) included in TS, from the program information analyzer unit 54, thereby managing the present time, and it also executes a notice of an alarm (i.e., a notice of arrival of designated time) and/or a one-shot timer (i.e., a notice of passing a predetermined constant time-period), in accordance with a request of each module, with using a counter, which the time 34 has therein.

A network controller unit 56 controls the network I/F 25, and thereby executes obtaining of various kinds or categories of information and TS, from a specific URL (Unique Resource Locater) and/or a specific IP (Internet Protocol). A decoding controller unit 57 controls the video decoding apparatus 30 and the audio decoding apparatus 31, and thereby to execute starting or stopping of the decoding, and it also obtains the information included in the stream.

A recording/reproducing controller unit 58 controls the recording/reproducing controller apparatus 27, and thereby reading out a signal from the recording medium 26, especially, from a specific position of a specific content, or in the format of an arbitrary read-out (an ordinary reproduction, a fast-forward, a rewinding, and a pause). It also controls the recording of the signal, which is inputted into the recording/reproducing controller apparatus 27, onto the recording medium 26.

A tuning controller unit 59 controls the tuner 23, the descrambler 24, the signal exchanger device 28, the multiplex dividing apparatus 29, and also the decoding controller unit 57, so as to execute receiving of the broadcast and recording of the broadcast signal. Or, it executes the reproduction from the recording medium, and it also executes that control until when the video signal and the audio signal are outputted. Details of the operations of receiving the broadcast and/or recording operation of the broadcast signal will be mentioned later.

An OSD producer unit 60 produces OSD data including a specific message therein, and it gives such an instruction to a screen structure controller unit 61, that it outputs the video signal with superimposing the OSD data that is produced thereon. Herein, the OSD producer unit 60 produces OSD data having a parallax therein, such as, that for the left-side eye and that for the right-side eye, for example, and executes a display of message in the 3D, by requesting the screen structure controller unit 61 to make a 3D display upon basis of the data for the left-side eye and that for the right-side eye.

The screen structure controller unit 61 controls the screen structure controlling apparatus 32, thereby to superimpose the OSD, which is inputted from the OSD producer unit 60, onto the video, which is inputted from the video decoding apparatus 30, and it further executes processing (e.g., a scaling, a P-in-P, a 3D display, etc.) on the video, depending on necessity thereof; thereby providing an output to an outside. Each one of the function blocks provides such the function as was mentioned above.

<Broadcast Receipt>

Herein, explanation will be given about controlling steps and flows of the signals, in particular, when executing receipt of the broadcast. First of all, the system controller unit 51, when receiving the instruction made by the user (for example, pushing-down of a CH button of a remote controller), being indicative of receipt of the broadcast of a specific channel (CH), for example, from the user instruction receiver unit 52, gives the tuning controller unit 59 an instruction to make a tuning to CH, which the user designates (hereinafter, “a designated CH”).

The tuning controller unit 59, upon receipt of the instruction mentioned above, instructs the tuner 23 to execute a receiving control (i.e., tuning to the designated frequency band, the decoding process of the broadcast signal, and the error correction process), thereby to output the TS to the descrambler 24.

Next, the tuning controller unit 59 instructs the descrambler 24 to descramble the TS mentioned above, and it also instructs the signal exchanger device 28 to output the input from the descrambler 24 to the multiplex dividing apparatus 29, and it further instructs the multiplex dividing apparatus 29 to execute multiplex division upon the TS inputted, to output the video ES, which is multiplex divided, to the video decoding apparatus 30, and also to output the audio ES to the audio decoding apparatus 31.

Also, the tuning controller unit 59 instructs the decoding controller unit 57 to decode the video ES and the audio ES, which are inputted into the video decoding apparatus 30 and the audio decoding apparatus 31. The decoding controller unit 57 controls the video decoding apparatus 30, so as to output the video signal decoded therein, to the screen structure controlling apparatus 32, and it also controls the audio decoding apparatus 31, so as to output the audio signal decoded therein, to the audio output 42. In this manner is executed the control for outputting the video and the audio of the CH, which the user designates.

Also, in order to display a CH banner (i.e., OSD for displaying a CH number or a program name, etc.) when the tuning is made, the system controller unit 51 instructs the OSD producer unit 60 to produce a CH banner, and thereby to output it. The OSD producer unit 60, upon receipt of the instruction mentioned above, transmits the produced CH banner to the screen structure controller unit 61, and the screen structure controller unit 61, upon receipt of the data mentioned above, executes a control therein, thereby to output the video signal with superimposing the CH banner thereon. In this manner is executed the display of the message when tuning, etc.

### <Recording of Broadcast Signal>

Next, explanation will be given about recording control of broadcast signal and flows of the signals. When executing the recording of a specific CH, the system controller unit 51 instructs the tuning controller unit 59 to tune to the specific CH and to output the signal to the recording/reproducing controlling apparatus.

The tuning controller unit 59, upon receipt of the instruction mentioned above, similar to the broadcast receiving process mentioned above, gives an instruction to the tuner 23 for a control of receiving the designated CH, and thereby controlling the descrambler 24 to descramble the TS, which is received from the tuner 23, and the signal exchanger device 28 to output the input from the descrambler 24, into the recording/reproducing controller apparatus 27.

Also, the system controller unit 51 instructs the recording/reproducing controller unit 58 to record the input TS into the recording/reproducing controller apparatus 27, therein. The recording/reproducing controller unit 58, upon receipt of the instruction mentioned above, executes the necessary process, such as, the encoding, etc., and also produces additional information necessary when recording/reproducing (i.e., content information, such as, the program information of recording CH, a bit rate, etc.), or after executing the recording onto the management data (i.e., an ID of recording content, a recording position on the recording medium 26, a recording format, encoded information, etc.), it executes a process for writing the TS mentioned above, the additional data, and the management data onto the recording medium 28. In this manner the recording of the broadcast signal is executed.

<Reproducing from Recording Medium>

Next, explanation will be given on a process for reproducing from the recording medium. When executing the reproduction upon a specific program, the system controller unit 51 instructs the recording/reproducing controller unit 58 to reproduce the specific program. As such instruction in this instance, an ID of the content and a position of starting the reproduction (for example, a top of the program, a position of 10 min. from the top, the following to the previous, a position of 100 Mbytes from the top, etc.) are indicated.

The recording/reproducing controller unit 58, upon receipt of the instruction mentioned above, controls the recording/reproducing controller apparatus 27, and thereby reading out the signal (TS) from the recording medium with using the additional information and/or the management data; and after executing the necessary process(es), such as, the decryption, etc., it executes such a process therein, that the TS is outputted to the signal exchanger device 28 therefrom.

Also, the system controller unit 51 instructs the tuning controller unit 59 to output the video/audio signals of the reproduced signal. The tuning controller unit 59, upon receipt of the instruction mentioned above, controls the signal exchanger device 28, in such that it outputs the input from the recording/reproducing controller apparatus 27 to the multiplex dividing apparatus 29, and it also instructs the multiplex dividing apparatus 29, to execute the multiplex division upon the TS inputted and to output the video ES divided from multiplex to the video decoding apparatus 30, and further to output the audio ES divided from multiplex to the audio decoding apparatus 31.

Also, the tuning controller unit 59 instructs the decoding controller unit 57 to decode the video ES and the audio ES, which are inputted into the video decoding apparatus 30 and the audio decoding apparatus 31. The decoding controller unit 57, upon receipt of the decoding instruction mentioned above, controls the video decoding apparatus 30, so as to output the video signal decoded to the screen structure controlling apparatus 32, and also controls the audio decoding apparatus 31, so as to output the audio signal decoded to the audio output 42. In this manner is executed the process for reproducing the signal from the recording medium.

<Method for Displaying 3D Picture> As a method for displaying a 3D picture, which can be applied into the present invention, there are a several numbers of methods, i.e., providing the videos for the left-side eye and for the right-side eye, to let the left-side eye and the right-side eye to sense the parallax therebetween, and thereby brining about a recognition of a solid or cubic body for a human being.

As a one of the methods is an active shutter method, wherein shading is executed, alternately, on both sides of glasses, which the user puts on, with using a liquid crystal shutter, etc., while displaying the videos for the left-side eyes and the right-side eye, in synchronism therewith, and thereby generating the parallax on the screen reflecting on the left and the right eyes.

In this case, the receiving apparatus 4 outputs the sync signal and/or the control signal, from the control signal output unit 43 and/or the equipment control signal transmitter unit 44, to the active shutter method glasses, which the user puts on. Also, the video signal is outputted from the video signal output unit 41 to an external 3D video display apparatus; thereby the videos for the left-side eye and the right-side eye are displayed, alternately. Or, the similar display is executed on a 3D video display, which the receiving apparatus 4 has therein. With doing so, the user, who puts on the active shutter method glasses, is able to view/listen the 3D picture or video on that 3D video display apparatus or the 3D video display, which the receiving apparatus 4 has therein.

Also, as other method thereof is a polarization method of applying or treating linear polarization coats, being perpendicular to each other in the linear polarization thereof, or applying or treating circular polarization coats, being opposite to each other in the rotation direction of the circular polarization thereof, on both sides of the glasses, which the user puts on, so as to output the videos, being polarized for the left-side eye and the video for the right-side eye, respectively, corresponding to the polarizations of the glasses for the left-side eye and the right-side eye, and thereby generating the parallax between the left-side eye and the right-side eye.

In this case, the receiving apparatus 4 outputs the video signal from the video signal output unit 41 to the external 3D video display apparatus, and thereby displays the video for the left-side eye and the video for the right-side eye, under the condition of polarization differing from each other. Or, the similar display is made on the 3D video display, which the receiving apparatus 4 has therein. With doing this, the user who puts on the polarization method glasses is able to view the 3D video or picture on that 3D video display apparatus or the 3D display, which the receiving apparatus 4 has therein. However, with the polarization method, since the viewing/listening of the 3D video can be made, without transmitting the sync signal and the control signal from the receiving apparatus 4 thereto, there is no necessity of outputting the sync signal and the control signal from the control signal output unit 43 and/or the equipment control signal transmitter unit 44.

And, other than those, it is also possible to apply a color separation method therein, separating the videos for the left-side and the right-side eyes depending on the color thereof. Also, there can be applied a parallax barrier method for creating a 3D video or picture with using the parallax barrier, which can be watched by naked eyes, etc.

However, the 3D display method according to the present invention should not be limited to a specific method.

### <Method for Determining 3D Program>

As a method for determining a 3D program, by introducing information for determining on whether it is a 3D program or not, newly, to be included in the various kinds or categories of data and/or a descriptor, which is/are included in the program information of the broadcast signal and the reproduced signal, it is possible to determined on whether it is the 3D program or not, by obtaining the information from that descriptor. In more details, while including the information for determining on whether it is the 3D program or not, newly, within a component descriptor or a component group descriptor, which is described within a table, such as, a PMT (Program Map Table) or an EIT (Event Information Table) [schedule basic/schedule extended/present/following], etc., which are regulated in a broadcast regulation (formulated in ARIB/DVB/ATSC, etc.) or a disc coding regulation, or transmitting the new descriptor for use of determination of the 3D program, and so on, those information are confirmed on the receiving apparatus side, and thereby determining on whether it is the 3D program or not. Those information are attached to the broadcast signal within the transmitting apparatus mentioned above, to be transmitted therefrom. In the transmitting apparatus, those information are attached to the broadcast signal, for example, in the management information conferrer unit 16.

As a way of use of each of those tables, for example, with PMT, since it describes therein only the information of the present program, it is impossible to confirm the information of future programs; however, it has a feature of being high in reliability thereof. On the other hand, with EIT (Event Information Table) [schedule basic/schedule extended/present/following], it is possible to obtain, not only the information of the present program, but also that of the future programs; however, there are following demerits, such as, that it takes a long time until when completing the reception thereof, that it needs a lot of memory areas for keeping thereof, and that the reliability is low because it is the phenomenon in the future.

With EIT [following], since it is possible to obtain the information of the program of a next broadcasting time, it is suitable to be applied into the present embodiment. Also, EIT [present], since it can be applied for obtaining the program information at present, it is possible to obtain the information other than those obtainable with PMT.

Next, explanation will be given about the descriptor in each table, in more details thereof. First of all, although it is possible to determine the format of ES, depending on a kind or category of data within “stream_type”, which is described in 2^{nd} loop (a loop for each ES) of PMT; however, if there is description indicating that the present stream is the 3D video, among of those, it is determined that the program is the 3D program (for example, assuming 0x10: MPEG 2 SYSTEM 3D encode, etc., it is newly assigned as the “stream_type” for indicating the 3D video stream, and then confirmation is made on whether such value exists or not, in the program information). Or, other than the “stream_type”, into a region or area, which is determined to be “reserved” at present, among the PMT, is assigned a 2D/3D bit for discriminating between the 3D program and the 2D program, newly, and then, the determination may be made upon that region. With the EIT, similar to the above, the 2D/3D bit may be assigned, newly, into the reserved region, thereby to make the determination.

In case where determination is made by the component descriptor, a type indicating the 3D video is assigned to “component_type” of the component descriptor, and if there is that, the “component_type” of which indicates the 3D, then it is possible to determine that the program is the 3D program (for example, 0xB9 is assigned with “3D video 1080i (1125i) aspect ratio equal to 16:9 or more”, etc., and then conformation is made that such value exists in the program information of the target program).

Also, as a method for determining by the component group descriptor, description of indicating 3D service is assigned to a value of “component_group_type”, and if the value of the “component_group_type” indicates the 3D service, it is possible to determine that it is the 3D program (for example, a value “010” in a bit field is assigned to a 3D television service, etc., and then confirmation is made that such value exists in the program information of the target program).

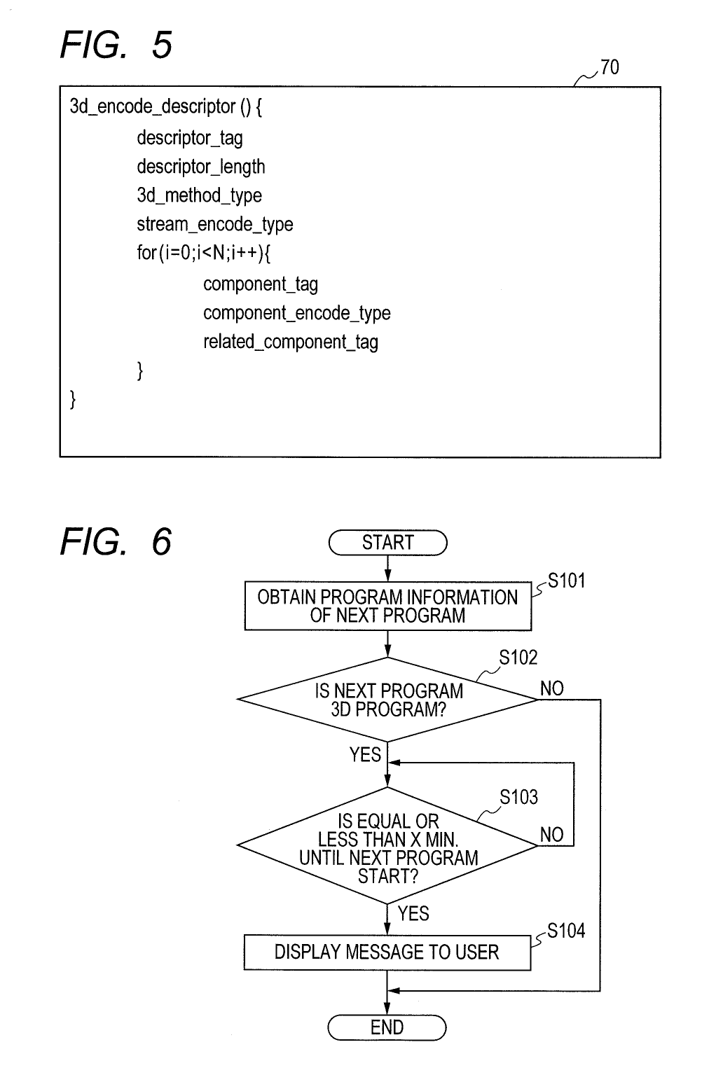

Also, about a method of newly assigning the descriptor for use of determination of the 3D program, an example of the descriptor (i.e., 3D coding identifier) is shown in FIG. 5. With this example, there are shown only members, which are necessary for the explanation of this time, however it can be considered that they have a member (s) other than those, or that plural numbers of the members are combined or unified as one unit, or that one member is divided into plural numbers of members, each having detailed information.

About “descriptor_tag” of the descriptor (i.e., 3D coding identifier) shown in FIG. 5, there is described a value (for example, “0x80”), which can identify that this identifier is the 3D coding identifier, and in “descriptor_length” us described a size of this identifier. About “3d_method_e”, there is described a kind or category of a 3D video reproducing method: such as, a frame sequential method for outputting the video for the left-side eye and the video for the right-side eye, alternately; a line-by-line method of storing the video for the left-side eye and the video for the right-side eye within one screen, line by line; a side-by-side method of dividing one (1) screen into the left and the right and storing the video for the left-side eye and the video for the right-side eye, as the videos divided into the left and the right; or a top-and-bottom method of dividing one (1) screen into the top and the bottom and storing the video for the left-side eye and the video for the right-side eye, as the videos divided into the top and the bottom, etc., for example, wherein it is possible to make an operation, for example, changing the decoding method and/or the display method, or displaying a message that reproducing/display cannot be made by the receiving apparatus receiving thereof, etc., by confirming that value.

“stream_encode_type” describes therein that the coding method of the video ES is, for example, MPEG4-AVC, MPEG2 or other than those, or that it is a coding method depending on other stream or not, etc. An inside of “for loop” indicates in which manner each component is encoded, “component_tag” identifies a component designating the information by the present loop, and “component_encode_type” describes therein on whether it is possible to decode without referring to other component(s) or not, or it is necessary to refer to other component(s) or not, etc., as the coding method for that each component, and in particular, when referring to the other component(s), an ID of the component to be referred is described in next “related_component_tag”.

When determining on whether the program of target is the 3D program or not, first of all, determine can be made on whether this identifier exists or not, and in such case, since there is no necessity of analyzing the descriptor mentioned above, then the process is easy. Also, if the 3D coding method (i.e., the 3d_method_type mentioned above) included in the identifier mentioned above is a 3D method, which the apparatus can deal with, then there can be considered a method of determining the next coming program to be the 3D program. In such case, the process for analyzing the describer comes to be complex; however, it is possible to prevent the apparatus from an operation of executing a process of displaying a message to the 3D program, which the apparatus cannot deal with, or a process for recording.

Also, with newly assigning the 3D program service to the information of “service_type” included in NIT or SDT (for example, 0x11: “3D digital video service”), it is possible to determine it to be the 3D program when obtaining the program information having the descriptor mentioned above. In this case, since the determination is made, not by a unit of the program, but by a unit of service (CH), although determination of the 3D program cannot be made on the next program within the same CH, but there is also an aspect that obtaining of information is easy because it is not by the unit of the program.

And, it is also possible to use the information, i.e., being 3D encoded, which is attached with various kinds of headers, such as, a sequence header, a picture header, etc., which are used when decoding the video ES. In that case, reliability of the information is higher than that of EIT or PMT mentioned above, however, there is a demerit that it takes a long time from when receiving the video stream and up to when analyzing it.

Also, about the program information, there is also a method for obtaining it through a communication path for exclusive use thereof (e.g., the broadcast signal, or the Internet). In that case, it is also possible to make the 3D program determination, in the similar manner, if there are a starting time of the program, CH (broadcast CH, URL or IP address) and an identifier indicating on whether that program is the 3D program or not.

In the explanation given in the above, the explanation was given about various kinds of information (i.e., the information included in the table or the descriptor), for determining to be the 3D video or not, by the user of the service (CH) or the program; however, there is no necessity of transmitting all of those, always, according to the present invention. It is enough to transmit the necessary information fitting to a mode of broadcast. Among of those information, the confirmation may be made on single information, respectively, thereby determining to be the 3D video or not, by the unit of the service (CH) or the program, or the determination may be made on whether the 3D video or not, by combining plural numbers of information by the user of the service (CH) or the program. In case where the determination is made by combining the plural numbers of information, although it is the 3D video broadcast service, however determination can be made, such as, that a part of the program is 2D video, etc. In case where such determination can be made, for the receiving apparatus, it is possible to explicitly indicates that the corresponding service is the “3D video broadcast service” on EPG, for example, and also, even if 2D video program(s) is/are mixed with, other than the 3D video service, in that service, it is possible to exchange the display control between the 3D video program and the 2D video program, when receiving the program, etc.

### <Display Method of 3D Content>

Next, explanation will be given about a process when reproducing a 3D content (i.e., digital content including the 3D video therein). Herein, explanation will be made, by taking a case where video ES for the left-side eye and video ES for the right-side eye are within one (1) TS, as an example thereof. First of all, when the user gives an exchange instruction (for example, push-down of a “3D” key of a remote controller), etc., for shifting to the 3D video, the user instruction receiver unit 52, receiving the key code mentioned above thereon, instructs the system controller unit 51 to exchange into the 3D video. The system controller unit 51, receiving the instruction mentioned above thereon, determines on whether the present program is the 3D program or not, through the method mentioned above.

If the present program is the 3D program, the system controller unit 51 instructs the tuning controller unit 59, first of all, to output the 3D video therefrom. The tuning controller unit 59, receiving the instruction mentioned above thereon, firstly obtains PID (packet ID) of the video ES for the left-side eye and video ES for the right-side eye and the 3D encoding method (for example, H.264 MVC) from the program information analyzer unit 54, and next, it controls the multiplex dividing apparatus 29 to execute multiplex division upon the video ES for the left-side eye and the video ES for the right-side eye mentioned above, thereby to output them therefrom.

Herein, the multiplex dividing apparatus 29 is controlled in such a manner that, for example, the video ES for the left-side eye is inputted into a first input of the video decoding apparatus while the right-side eye is inputted into a second input thereof. Thereafter, the tuning controller unit 59 transmits the information indicating that the video ES for the left-side eye is provided to the first input of the video decoding apparatus 30 while the video ES for the right-side eye to a second input thereof, as well as, the 3D encoding method mentioned above, to the decoding controller unit 57, and it also instructs it to decode those ES.

The decoding controller unit 57 receiving the instruction mentioned above thereon executes the decoding on the ES for the left-side eye and the ES for the right-side eye, respectively, and thereby outputting the video signals for the left-side eye and the right-side eye to the screen structure controlling apparatus 32. Herein, the system controller unit 51 instructs the screen structure controller unit 61 to execute 3D output of the videos. The screen structure controller unit 61 receiving the instruction mentioned above from the system controller unit 51 outputs the video signals for the left-side eye and the right-side eye, alternately, from the video signal output unit 41, or displays the videos on the 3D display, which the receiving apparatus 4 is provided with.

Also, in addition to that, the sync signal, with which each video signal can be determined to be that for the left-side eye or that for the right-side eye, is outputted from the control signal output unit 43. The external video output apparatus, receiving the video signals and the sync signal mentioned above thereon, outputs the videos for the left-side eye and the for the right-side eye, by fitting the video signals to the sync signal, and it also transmits the sync signal to a 3D view assistance device; thereby enabling to do the 3D display.

Also, when display the video signals mentioned above on the 3D display, which the receiving apparatus 4 is provided with, the sync signal mentioned above is outputted, via the equipment control signal transmitter unit 53 and the control signal transmitting/receiving unit 33, from the equipment control signal transmitter unit 44, to execute the control of the external 3D view assistance device (for example, exchange of shielding of the active shutter); thereby executing the 3D display.

In case where the 2D display is executed, in particular, when the user gives an instruction to change to the 2D video (for example, push-down of a “2D” key of the remote controller), the user instruction receiver unit 52 receiving the key code mentioned above instructs the system controller unit 51 to exchange the signal to the 2D video. The system controller unit 51 receiving the instruction mentioned above thereon, first of all, instructs the tuning controller unit 59 to output the 2D video therefrom.

The tuning controller unit 59 receiving the instruction mentioned above thereon, first of all, obtains the PID of ES (for example, ES having a default tag) for use of 2D video from the program information analyzer unit 54, and controls the multiplex dividing apparatus 29 to output the ES mentioned above to the video decoding apparatus 30. Thereafter, the tuning controller unit 59 instructs the decoding controller unit 57 to decode the ES mentioned above therein.

The decoding controller unit 57 receiving the instruction mentioned above thereon executes decoding of the ES mentioned above, and thereby outputs the video signal to the screen structure controlling apparatus 32. Herein, the system controller unit 51 controls the screen structure controller unit 61 so that it output the 2D output of video. The screen structure controller unit 61 receiving the instruction mentioned above thereon outputs the video signal, which is inputted into the screen structure controlling apparatus 32, from the video signal output unit 41. In this manner, the 2D display is executed.

Next, explanation will be given about a process for displaying the 3D content under a predetermined condition. In FIG. 6 is shown an example of a flow, which is executed in the system controller unit 51, when the time until a startup of the next program is changed, such as, due to a tuning or a passage of a predetermined time-period, etc. First of all, the system controller unit 51 obtains the program information of the next program from the program information analyzer unit 54 (S101), and in accordance with the method for determination of the 3D program mentioned above, it determines on whether the next program is the 3D program or not.

In case where the next program is not the 3D program (“no” in S102), the flow is ended but without executing any process, in particular. In case where the next program is the 3D program (“yes” in S102), the time up to the startup of the next program is calculated. In more details, starting time of the next program or ending time of the present program is obtained from EIT of the program information obtained, while obtaining the present time from the time manager unit 55, and thereby the difference therebetween is calculated.

In case where the time until when the next program will start is not equal to or less than X minutes (“no” in S103), the flow waits until the time X minutes before the startup of the next program, but without executing any process, in particular. In case where the time until when the next program will start is equal to or less than X minutes (“yes” in S103), a message is displayed, indicating that the 3D program will starts, soon, to the user (S104).

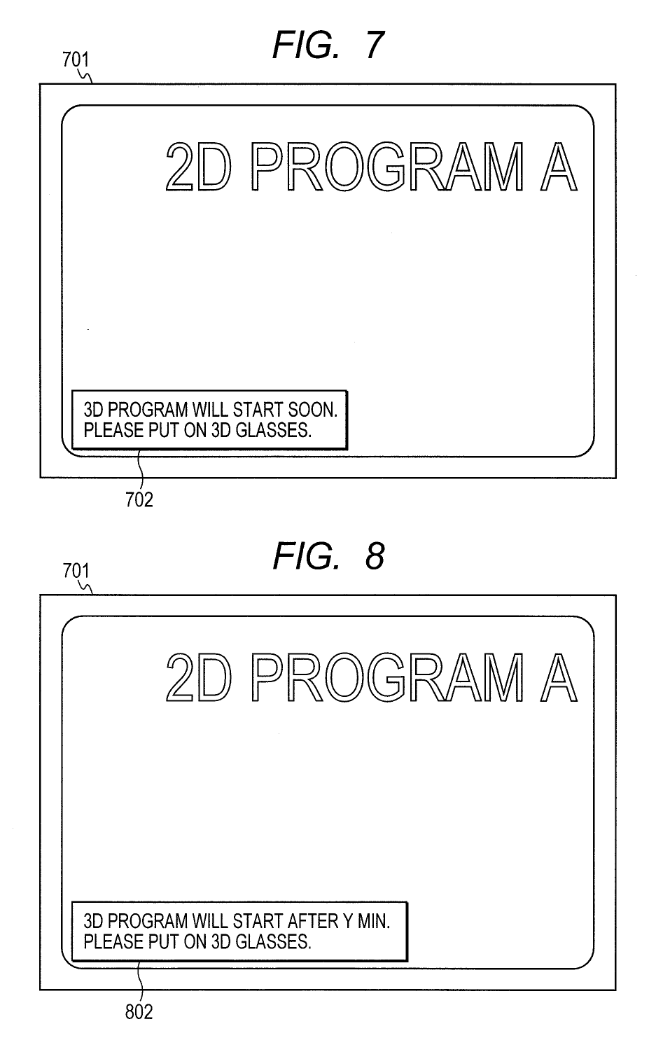

FIG. 7 shows an example of display of the message at that time. A reference numeral 701 depicts a screen as a whole, on which the apparatus makes the display, while 702 depicts the message, which the apparatus displays. In this manner, before starting the 3D program, it is possible to urge the user to pay attention for preparing the 3D view assistance device.

With the determination time X until the time when the program will starts mentioned above, if X is small, then there is brought about a possibility that the user cannot make preparation for the 3D viewing. Or, if making X large, there are brought about such demerits, i.e., displaying the message for a long time obstructs the viewing/listening, and a long interval is made after completion of the preparation, and therefore it is necessary to adjust it to an appropriate time-period.

Also, when displaying the message to the user, the starting time of the next program may be displayed, in more details thereof. An example of the screen display in that case is shown in FIG. 8. A reference numeral 802 depicts the message indicating the time until when the 3D program will start. Herein, description is made by a unit of minute, but it may be made by a unit of second. In that case, for the user, it is possible to know the starting time of the next program, in the details thereof; however there is also demerit that a load of processing comes to be high.

However, although FIG. 8 shows the example of displaying the time-period until the 3D program will start, but it is also possible to display the time when the 3D program will start. In case where the 3D program will start 9:00 PM, for example, a message, such as, “3D program will starts from 9:00 PM. Please put on 3D glasses” may be displayed.

With displaying such the message, for the user, it is possible to know the detailed starting time of the next program, and thereby she/he can make preparation for the 3D viewing/listening at an appropriate pace.

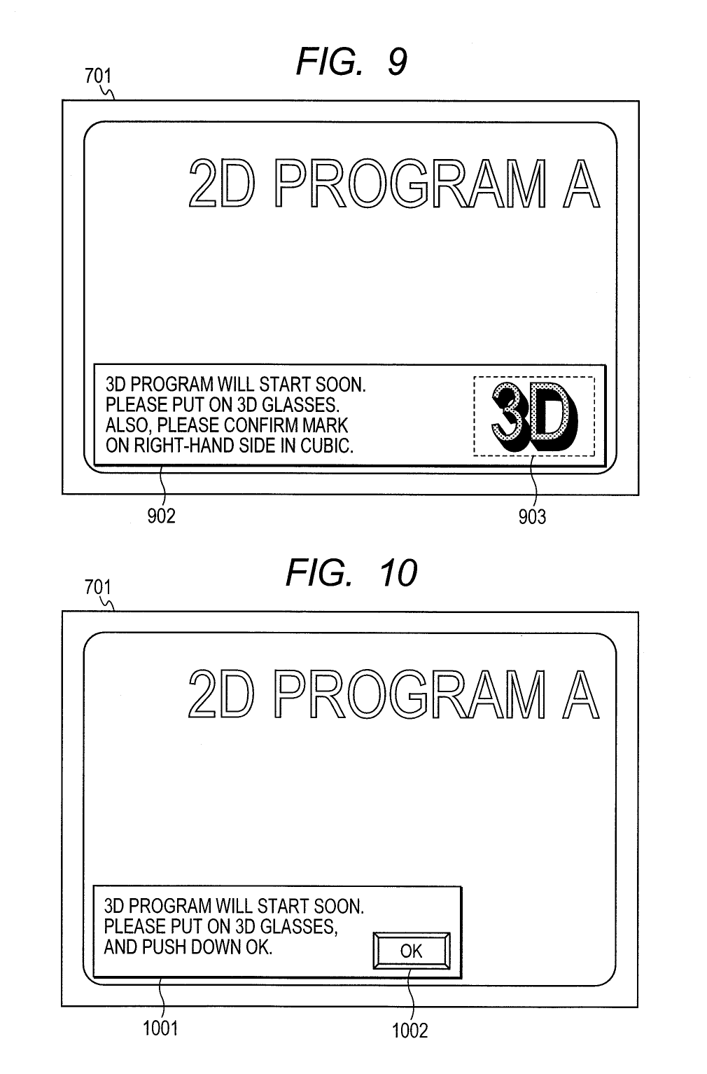

And, as is shown in FIG. 9, it can be also considered to add a mark (a 3D checkmark), which can be seen as a solid or cubic body, when using the 3D view assistance device. A reference numeral 902 depicts a message for predicting startup of the 3D program, and 903 a mark, which can be seen to be cubic when using the 3D view assistance device. With this, before starting the 3D program, the user can confirm a normal operation of the 3D viewing assistance device. For example, when a fault is generated in the 3D view assistance device (for example, shortage of a battery, a malfunction, etc.), then it is also possible to deal with it, such as, repair or exchange, etc., until when the program starts.

Next, explanation will be made about a method for determining a condition (i.e., 3D view preparation condition), i.e., if the preparation for the 3D viewing is completed or not, by the user, after noticing the user that the next program is the 3D, and thereby exchanging the video of the 3D program to the 2D display or the 3D display.

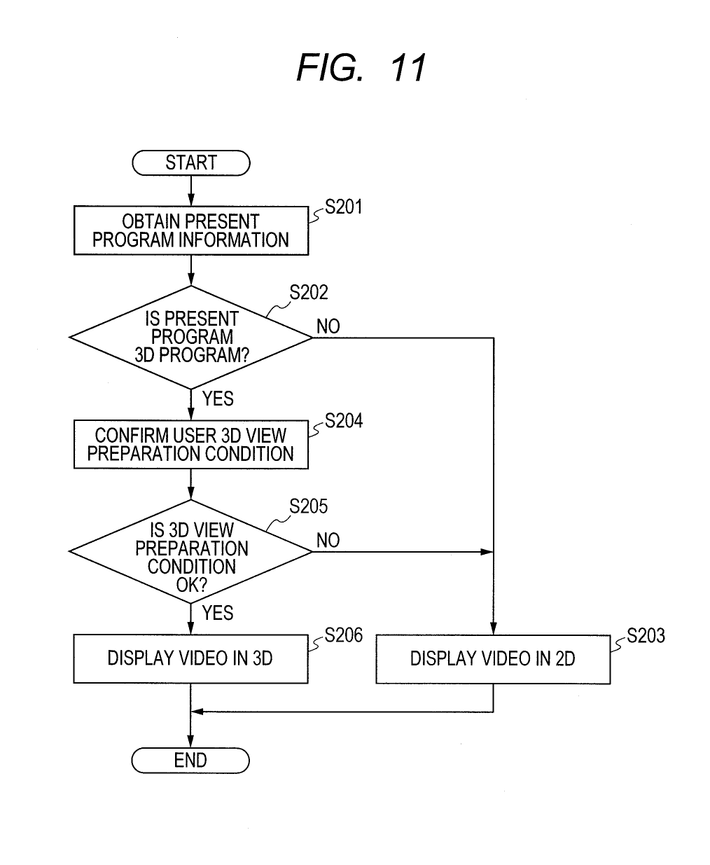

With the method for noticing the user that the next program is the 3D, it is as was mentioned above. However, with the message to be displayed for the user in the step S104, it differs from in an aspect that an object is displayed, for the user to make a response (hereinafter, “user response receiving object”; for example, a button on OSD). An example of this message is shown in FIG. 10.

A reference numeral 1001 depicts the entire message, 1002 the button for the user to make the response, respectively. When the message 1001 shown in FIG. 10 is displayed, and if the user pushes down an “OK” button of the remote controller, for example, the user instruction receiver unit 52 notices to the system controller unit 51 that the “OK” is pushed down.

The system controller unit 51 receiving the notice mentioned above thereon reserves a fact that the 3D view preparation condition of the user is in the “OK”, as a condition therein. Next, explanation will be made about a processing flow within the system controller unit 51, after patting a time, when the present program becomes the 3D program, by referring to FIG. 11.

The system controller unit 51 obtains the program information of the present program from the program information analyzer unit 54 (S201), and it determines on whether the present program is the 3D program or not, in accordance with the method mentioned above. In case where the present program is not the 3D program (“no” in S202), such control is made that the video is displayed in the 2D, in accordance with the method mentioned above.

In case where the present program is the 3D program (“yes” in S202), then confirmation is made on the 3D view preparation condition, next (S204). In case where the 3D view preparation condition mentioned above, which is stored by the system controller unit 51, is not “OK” (“no” in S205), in the similar manner, control is made so as to display the video in the 2D (in S203).

In case where the 3D view preparation condition mentioned above is “OK” (“yes” in S205), with the method mentioned above, control is made so as to display the video in the 3D (S206). When it can be confirmed that the present program is the 3D program and that the user has completed the 3D view preparation, in this manner, then 3D display of the video is executed.

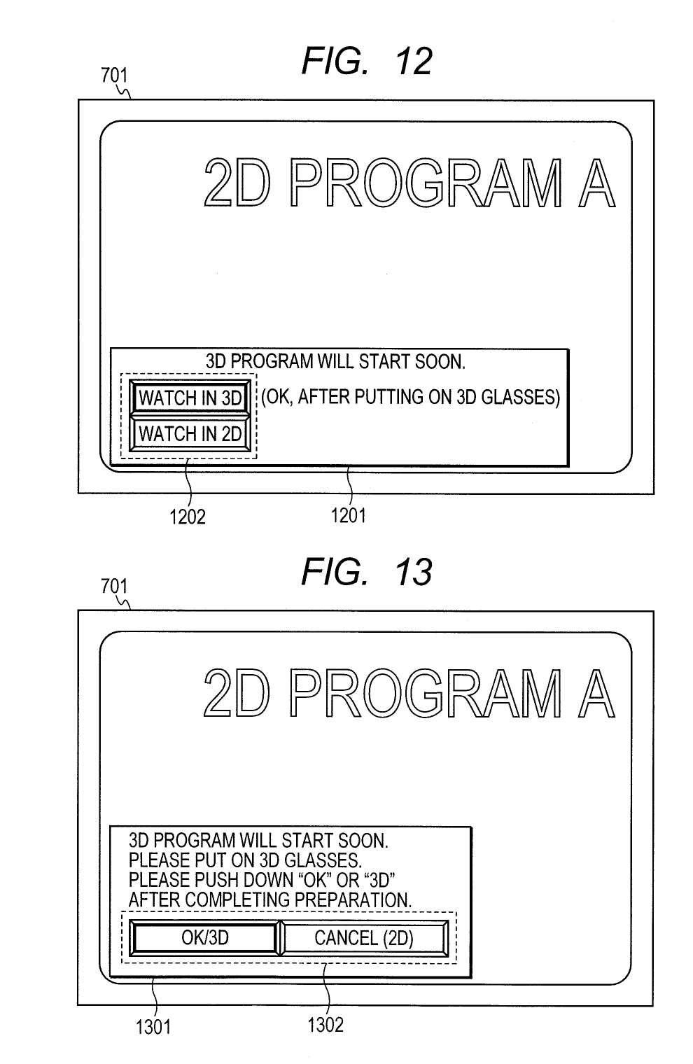

As the message display to be displayed in the step S104, not only of displaying “OK”, simply, as is shown in FIG. 10, but also a method of writing clearly on whether the method for displaying the next program should be the 2D video or the 3D video. An example of the message and the user response receiving object in that case will be shown in FIGS. 12 and 13.

With dosing so, comparing to the display of “OK” as was mentioned above, convenience can be risen to be high, i.e., the instruction can be displayed in the 2D, explicitly (when “watch in 2D” described in 1202 is pushed down, the user 3D view preparation condition is determined to be “NG”), etc., other than that an operation after the user pushes down the button can be easily decided, etc.

Also, though the explanation was given that the determination of the 3D view preparation condition of the user is made through an operation of a user menu by means of the remote controller, herein, however there are other methods other than that; i.e., a method for determining the 3D view preparation condition upon a user put on completion signal, which the 3D view assistance device generates, for example, or the determination may be made that the user puts on the 3D view assistance device, with photographing a viewing condition of the user by an image pickup device or apparatus, and thereby executing an image recognition or a face recognition form a result of the photographing mentioned above.

With doing the determination in this manner, it is possible to save time and effort of executing any operation on the receiving apparatus by the user, and further to avoid an erroneous setting between the 2D video view and the 3D video view by a mistake.

Also, as other method is a method for determining that the 3D view preparation condition is “NG” when the user pushes down a <3D> button of the remote controller, or for determining that the 3D view preparation condition is “NG” when the user pushes down a <2D> button or a <return> button or a <cancel> button. In this case, although the user can notice the condition of her/himself thereto, clearly and easily, however there can be considered a demerit of transmission of condition due to an mistake or a misunderstanding.

Further, in the example mentioned above, it can be also considered to execute the processes after determining only the program information of the next program, which is obtained in advance, without obtaining the information of the present program. In this case, within the step S201 shown in FIG. 11, there can be considered a method of using the program information, which is obtained in advance (for example, in the step S101 shown in FIG. 6), without executing the determination on whether the present program is the 3D program or not, in the step S201 shown in FIG. 11. In this case, although there can be considered a merit that the process configuration comes to be simple, etc.; however, there is also a demerit, i.e., there is a possibility that the 3D video exchanging process be executed also when the next program becomes not the 3D program, since the program schedule is changed, suddenly, etc.

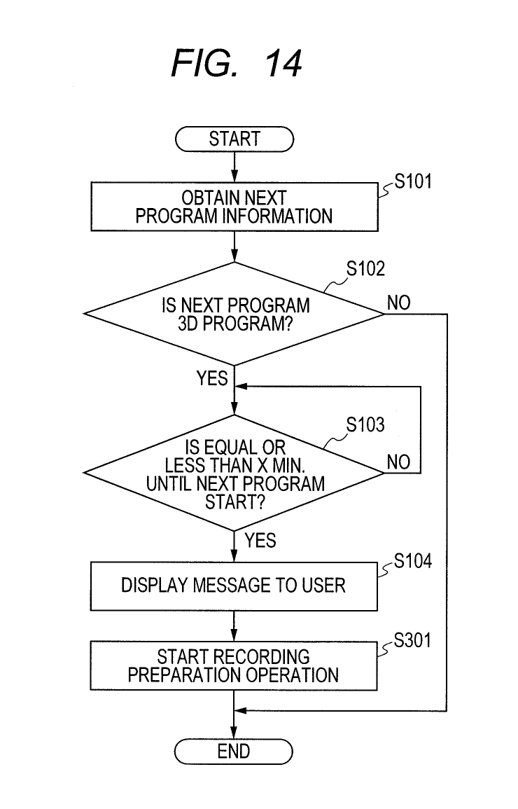

Next, explanation will be given about a processing flow within the system controller unit 51, in case where the program is enabled to be viewed from a beginning thereof, at a time when the user completes the preparation for viewing the 3D program, after starting the recording when the 3D program starts. The processes prior to the time when the 3D program starts are as described in FIG. 14. The steps S101 to S104 are same to those shown in FIG. 6; however, an aspect differing from those shown in FIG. 6 lies in that a step S301 is added, newly.

As detailed operations thereof, if the next program is the 3D program (“yes” in the step S102), and also if it is equal to X minutes or less than that until when the next program will starts (“yes” in the step S103), a recording preparation operation is started (S301). The recording preparation operation herein includes, for example, a releasing operation of the HDD from a standby condition or a spin-up operation thereof, or a startup of signal exchange for recoding or an execution of tuning for recording, etc., and about the operation(s) on a preparation stage for recording, it is preferable to execute it/them in this step.

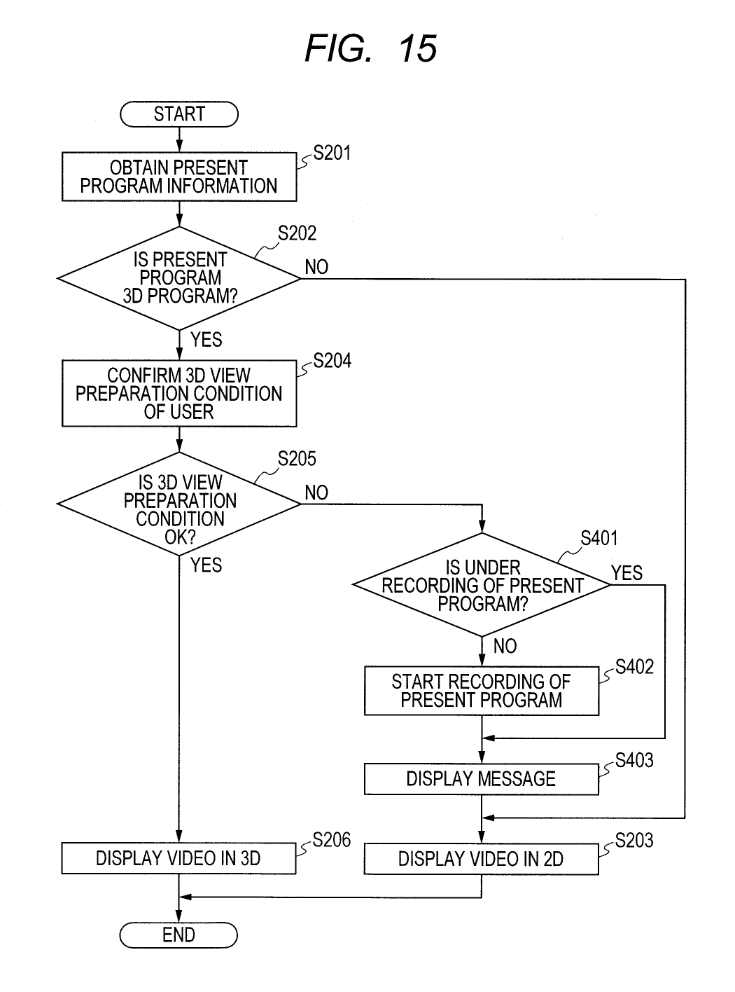

A processing flow within the system controller 51, in particular, after when the 3D program starts, thereafter, will be shown in FIG. 15. The processing flow until when the 3D view preparation condition of the user is determined (i.e., the steps S201, S202, S204 and S205) is same to that shown in FIG. 11.

Thereafter, in case where the 3D view preparation condition is not “OK” (“no” in the step S205), determination is made on whether the present program is under the recording condition, or not. In case where the present program is not under the recording condition (“no” in the step S401), then the recording of the present program is started (S402). In case where the present program is under the recording condition (“yes” in the step S401), the flow advances to the next step, without executing any step, in particular.

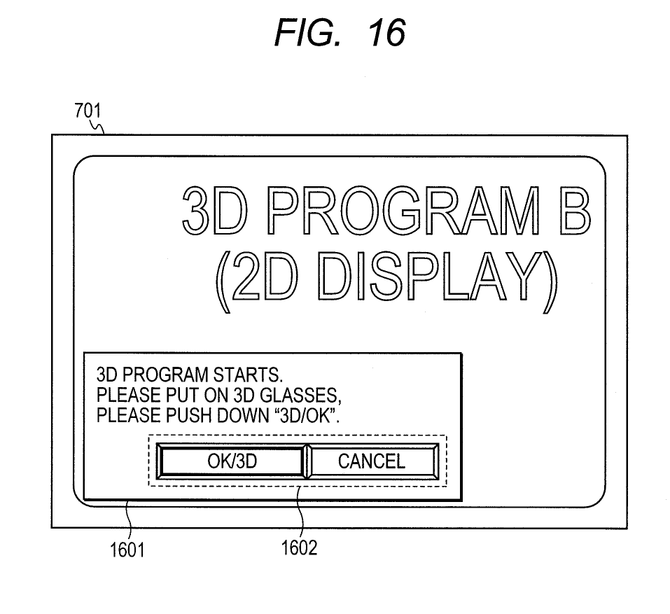

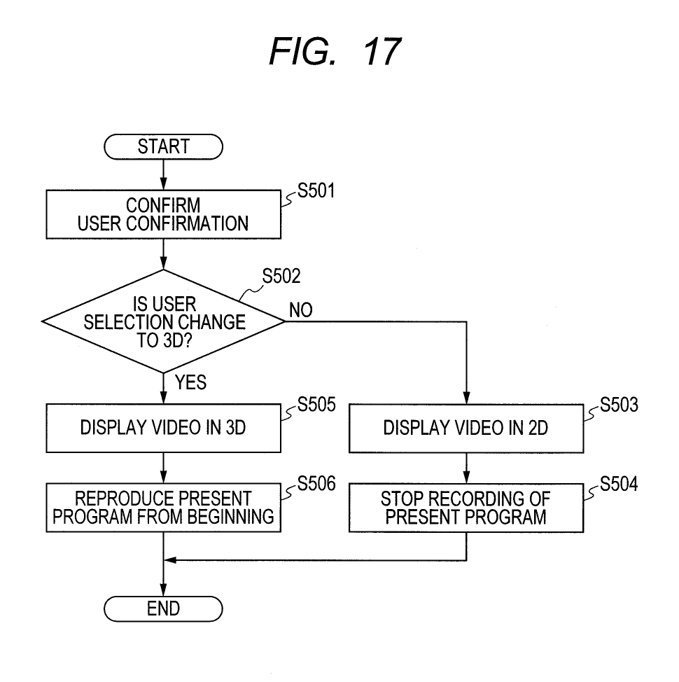

After executing the recording control, as is shown in FIG. 16, a message 1601 indicating that the 3D program starts, and also inquiring a selection of an operation thereafter to the user is displayed (S403), and the video is changed into the 2D display (S203); thereby the process is completed.

As an example of the methods for determining a user selection on the screen display shown in FIG. 16, when the user operating the remote controller pushes down the <3D> button of the remote controller, or when the user pushes down the <OK> button of the remote controller while she/he fits a cursor onto “OK/3D” on the screen, the user selection is determined to be “change to 3D”.

Or, when the user pushes down the <cancel> button or the <return> button of the remote controller, or when she/he pushes down the <OK> of the remote controller while fitting the cursor to the “cancel” on the screen, the user selection is determined to be “other than 3D exchange”. Other than this, for example, when she/he executes an operation for brining the 3D view preparation condition into “OK” (for example, put on of the glasses), the user selection is determined to be “change to 3D”.

The processing flow to be executed within the system controller unit 51, after the user executes the selection, will be shown in FIG. 17. The system controller unit 51 obtains a result of the user selection from the user instruction receiver unit 52 (S501). In case where the user selection is not the “change to 3D” (“no” in the step S502), the video is displayed in the 2D (S503), and the recording of the present program is stopped (S504) if it is executed; then, the flow is ended as it is.

In case where the user selection is the “change to 3D” (“yes” in the step S502), the video is displayed in the 3D (S505), and the reproducing process from the recording medium mentioned above is executed, so as to reproduce the present program from the beginning thereof.

In this manner, even in case where the user does not complete 3D view preparation when the reproduction of the program starts, it is possible, for the user, to view the program from the beginning thereof.

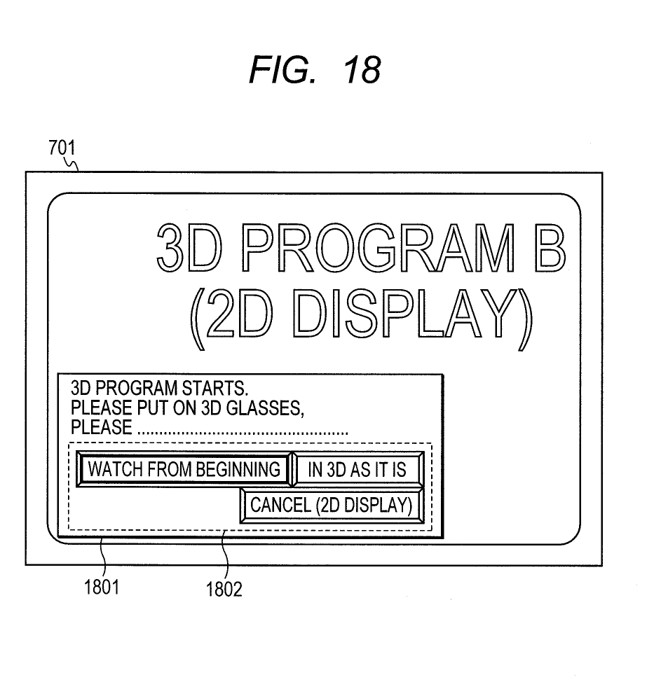

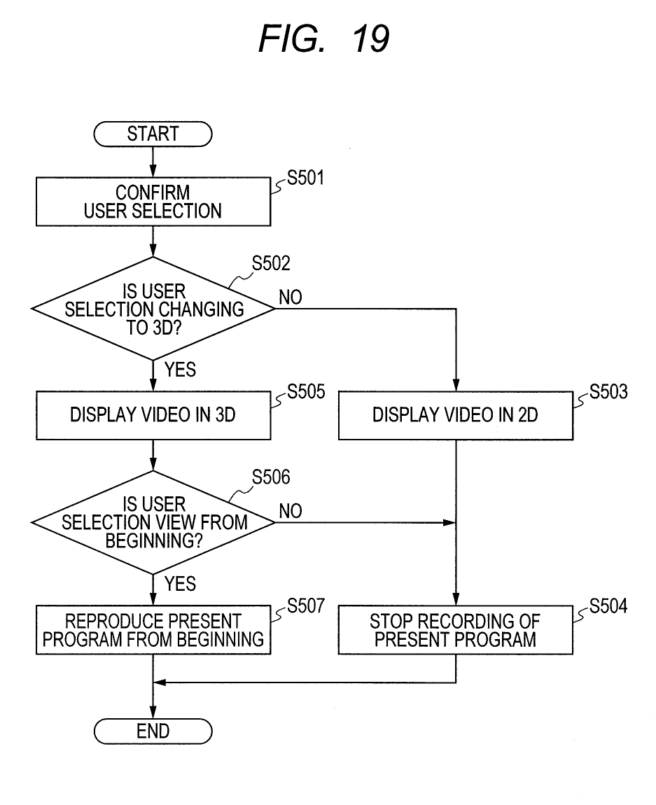

Also, as the message to be displayed in a step S403, if it contains a message indicating “view 3D as it is” therein, as is shown by 1801 in FIG. 18, it is possible to increase a number of operations, which the user can select, explicitly. As an example of a method for determining the user selection, in this case, if the user operates the remote controller, so that the cursor moves to fit “watch from beginning” on the screen, and when she/he pushes down the <OK> button of the remote controller, the user selection is determined to be “change to 3D and view from beginning”.

Or, if the user moves the cursor to fit “in 3D as it is” on the screen, and when she/he pushes down the <OK> button of the remote controller, then the user selection is determined to be “change to 3D and view from beginning”, or if the user moves the cursor to fit “cancel (2D display)” on the screen, and when she/he pushes down the <OK> button of the remote controller, then the user selection is determined to be “change to 2D”.

In this case, the processing flow to be executed after the user executes the selection, within the system controller unit 51, will be shown in FIG. 19. The operations from the step S501 to the step S505 are same to those shown in FIG. 17. In case where the selection of the user is “change to 3D” (“yes” in the step S502), determination is made on whether the user wishes to view/listen it from the beginning thereof or not, after displaying the video in the 3D (S505).

In case where the user selection is to view from beginning (“yes” in the step S506), the reproducing process from the recording medium mentioned above is executed, so as to reproduce the present program from the beginning thereof. In case where the user selection is not to view from beginning (“no” in the step S506), recording of the present program is stopped (S504), and reproduction is continued following as it is.

In this manner, depending on the result of the user selection, after the user completes the preparation for the 3D view, it is possible to select to view the program in the 3D, following from the present, to view the program in the 3D, from the beginning in the 3D, or to view/listen it in the 2D.

Herein, explanation will be given about a method for displaying only specific video and audio, but not displaying the video and audio of the program, until the time when user completes the preparation for the 3D view. This is made, for example, in case the program starts under the condition that the user does not complete the 3D view preparation yet, by taking a case where the user does not wished to watch the content until the time when the preparation thereof is completed (for example, a result can be seen, in a sports broadcast, etc.) into the consideration thereof.

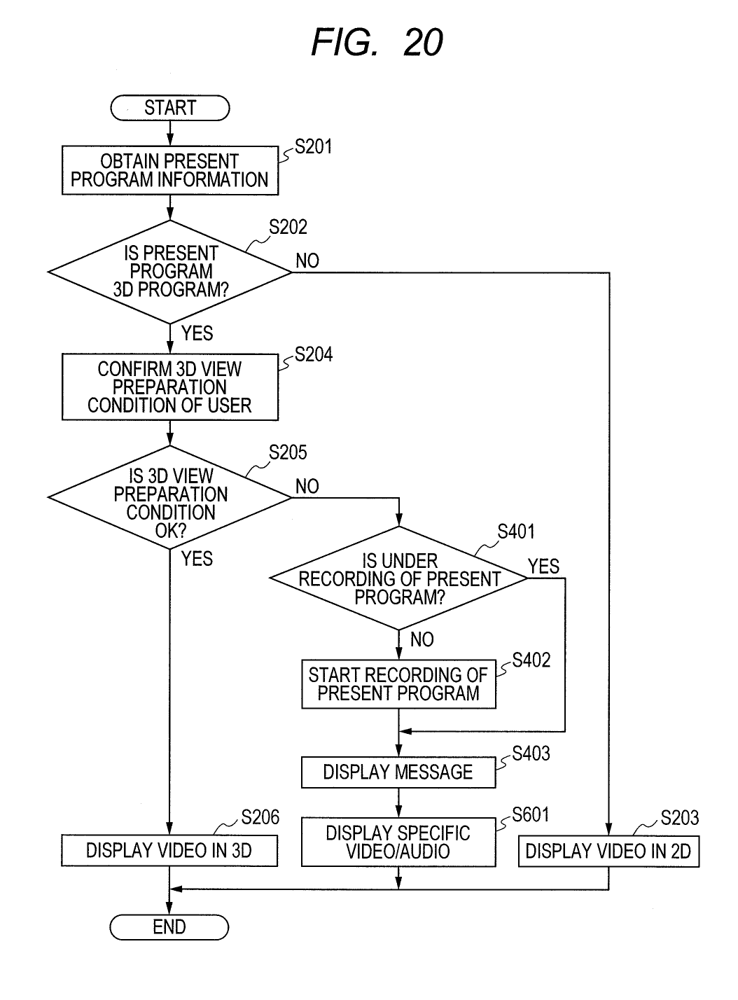

The processing flow, in such case, to be executed within the system controller 51 when the 3D program starts will be shown in FIG. 20. An aspect differing from the processing flow shown in FIG. 15 lies in that a step (S601) for displaying a specific video/audio is added therein, after displaying the message in the step S403.

As the specific video/audio mentioned herein can be listed up, for example, a message for accelerating the 3D preparation, a black screen, a still picture of the program, etc., as the video, while as the audio, there can be listed up no sound, or a music of a fixed pattern (e.g., an ambient music), etc.

With the display of a fixed pattern video (a message or an ambient picture, or a 3D video, etc.), it can be accomplished by reading out data from a ROM or the recording medium 25 within the video decoding apparatus 30 or not shown in the figures, and thereby decoding it within the video decoding apparatus 3 to be outputted therefrom.

Also, in case of the fixed pattern music (no sound, the ambient music), similar to the above, it can be accomplished by reading out data from an inside of the audio decoding apparatus 31 or a ROM or the recording medium 26, and thereby obtaining a decoded output or a mute of an output signal, etc.

With the output of a still picture of the program video, it can be accomplished by giving an instruction for reproduction of the program and also a temporary stop of the video, from the system controller unit 51 to the recording/reproducing controller unit 58. The processes within the system controller unit 51 after conducting the user selection are executed, in the similar manner to that shown in FIG. 17.

With this, it is possible to provide no output of the video and the audio of the program, during the time-period until the user completes the 3D view preparation.

In case where the user changes the CH by executing the tuning operation, etc., also in case where the present program is changed, the processing flow shown in FIG. 15 or FIG. 20 will be executed within the system controller unit 51. In this case, also the similar processes as was mentioned above will be executed.

With this, when the program is exchanged, there can be obtained the following effects, that the viewing program can be displayed in the 2D if it is other than the 3D program, that the video is changed into the 3D display when the user is already completed for the 3D view preparation, and that recording of the present program is executed when the user has not completed the 3D view preparation yet, while the message shown in FIG. 16 or 18 is displayed, and therefore the operation thereafter can be selected, etc.

In the recording operation of the 3D program mentioned above, there can be case where it consume electricity much more than a normal one, and/or where an operation load comes to an obstruct for the user to operate. In such case, it is possible to make a setup not to execute automatic recording of the 3D program by setting it by the user in advance.

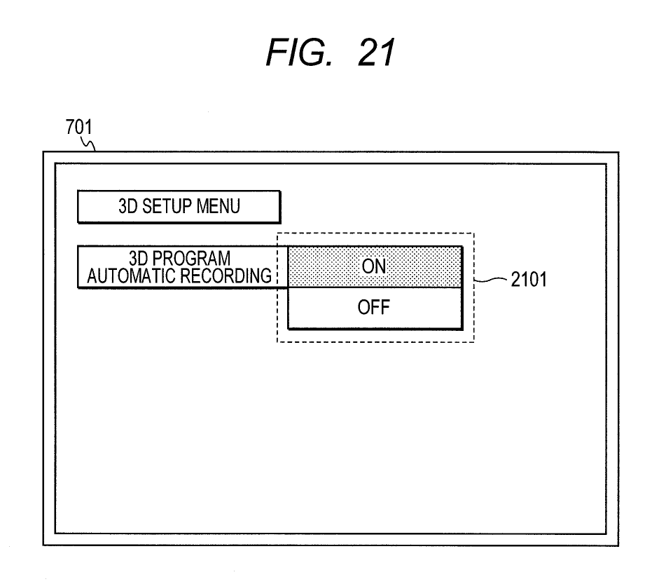

An example of a user setup screen will be shown in FIG. 21. This is a user menu for setting up presence/absence of automatic recording of the 3D program, wherein a reference numeral 2101 depicts a selectable button, i.e., with this, the user can select not to execute the automatic recording of the 3D program, by selecting “OFF”. When the user selects “OFF” on this screen, “OFF” of “3D program automatic recording”, which the user sets up, is noticed from the user instruction receiver unit 52 to the system controller unit 51.

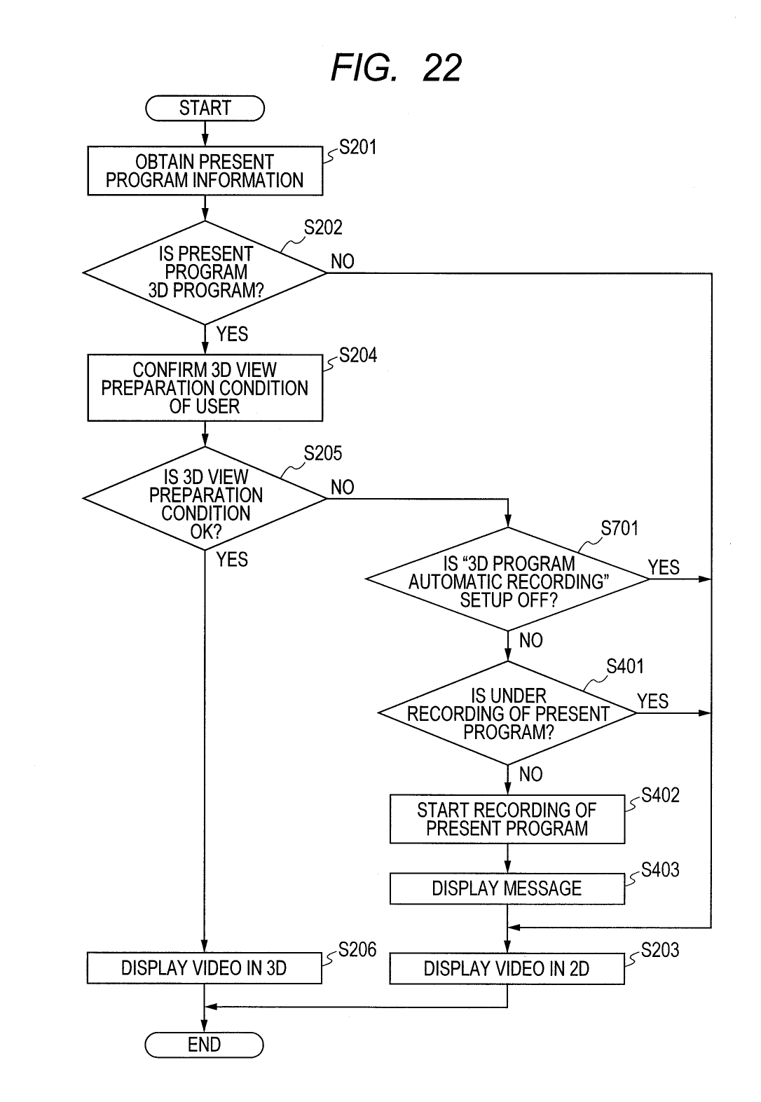

A flowchart in the system controller unit 51 will be shown in FIG. 22, corresponding to the user menu, which is explained by referring to FIG. 21. An aspect differing from the flowchart shown in FIGS. 15 and 20 lies in that a conformation is made on a user setup condition of the 3D program automatic recording, when the user 3D preparation is not “OK” (“no” in the step S205), and that the recording process is not executed in the step S402, when the user setup of “3D program automatic recording” is OFF (“yes” in the step S701).

In this manner, when the user does not wish, no automatic recording of the 3D program is executed, and therefore it is possible to suppress a consumption of electric power and to stop unnecessary operation(s).

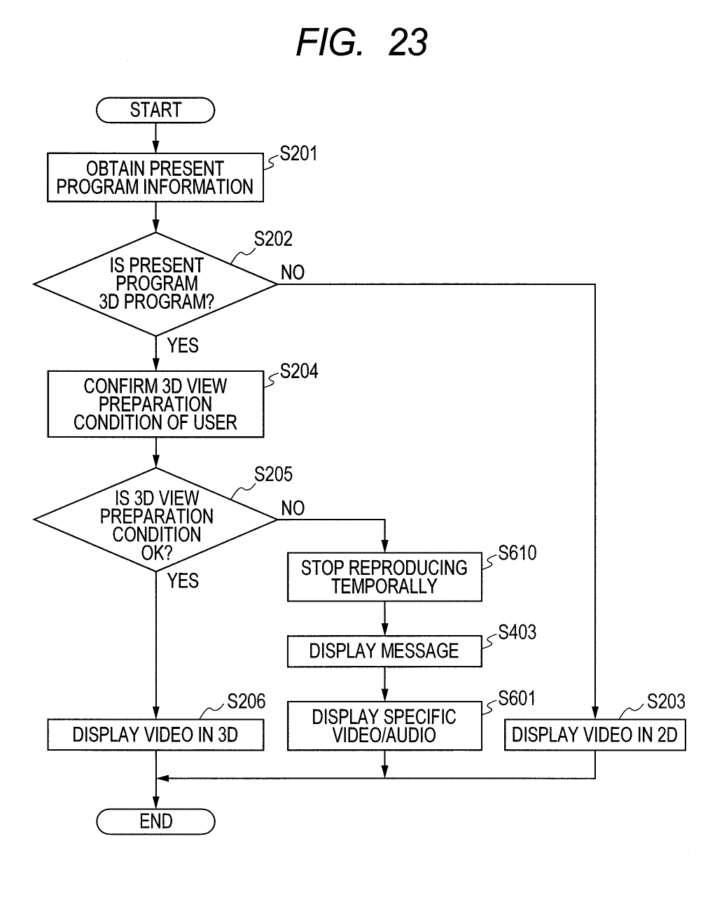

Next, explanation will be given about a method for executing a process of determining on whether the reproduction content is the 3D program or not, as well as, confirming the 3D preparation condition of the user, when starting the reproducing from the recording medium. The processing flow within the system controller unit 501, when starting the reproducing, will be shown in FIG. 23.

An aspect differing from the process mentioned above lies in that, there is no process to be executed before the program starts (FIG. 14), that there are not provided the determination of recording the present program (the step S401 in FIGS. 15, 20 and 22) and the recording process (the step S402 in FIGS. 15, 20 and 22), and that a reproduction temporary stop process (S601) is added, newly thereto.

Until the time when the determination is executed on the 3D view preparation condition, the processes are same to those shown in FIG. 15. Thereafter, in case where the 3D view preparation condition is “NG” (“no” in the step S205), the system controller unit 51 instructs the recording/reproducing controller unit 58 to stop the reproducing operation, temporally (S610). Thereafter, it executes display of such the message as shown in FIG. 16 (S403), and also displays the specific video/audio (S601), in accordance with the method similar to that, which was explained in the step S601 shown in FIG. 20.

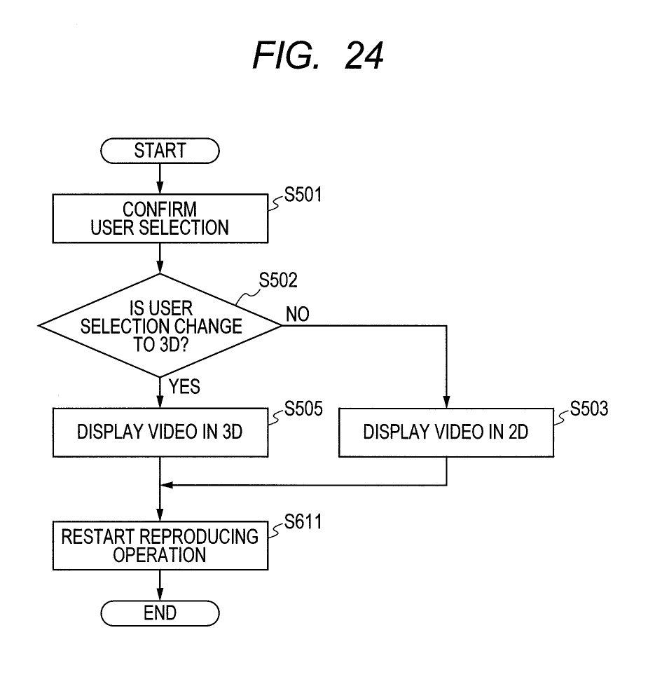

The processing flow to be executed within the system controller unit 51 after the user executes the selection will be shown in FIG. 24. The system controller unit 51 obtains the result of the user selection from the user instruction receiver unit 52 (S501). In case where the user selection is not “change to 3D” (“no” in the step S502), the video is displayed in the 2D (S503).

Also, in case where the selection of the user is “change to 3D” (“yes” in the step S502), the video is displayed in the 3D. Thereafter, the system controller unit 51 instructs the recording/reproducing controller unit 58 to re-starts the reproducing operation, which was stopped once (S611).

In this manner, when reproducing from the recording medium, the program to be viewed is displayed in the 2D if it is that other than the 3D program, or in case where the user is already prepared for the 3D view, the video or picture is changed to the 3D display, while the user is not prepared for the 3D view, the reproducing is stopped, temporally, wherein the message shown in FIG. 16 is displayed, so that she/he is able to select the operation thereafter, and after selecting the operation by the user, the program is reproduced in the video display fitting to the selection by the user. In this manner, in case of the reproducing operation can be also obtained an effect that saving of electric power can be achieved, by setting the reproducing operation to stop, temporally, until the time when the user completes the 3D view preparation.

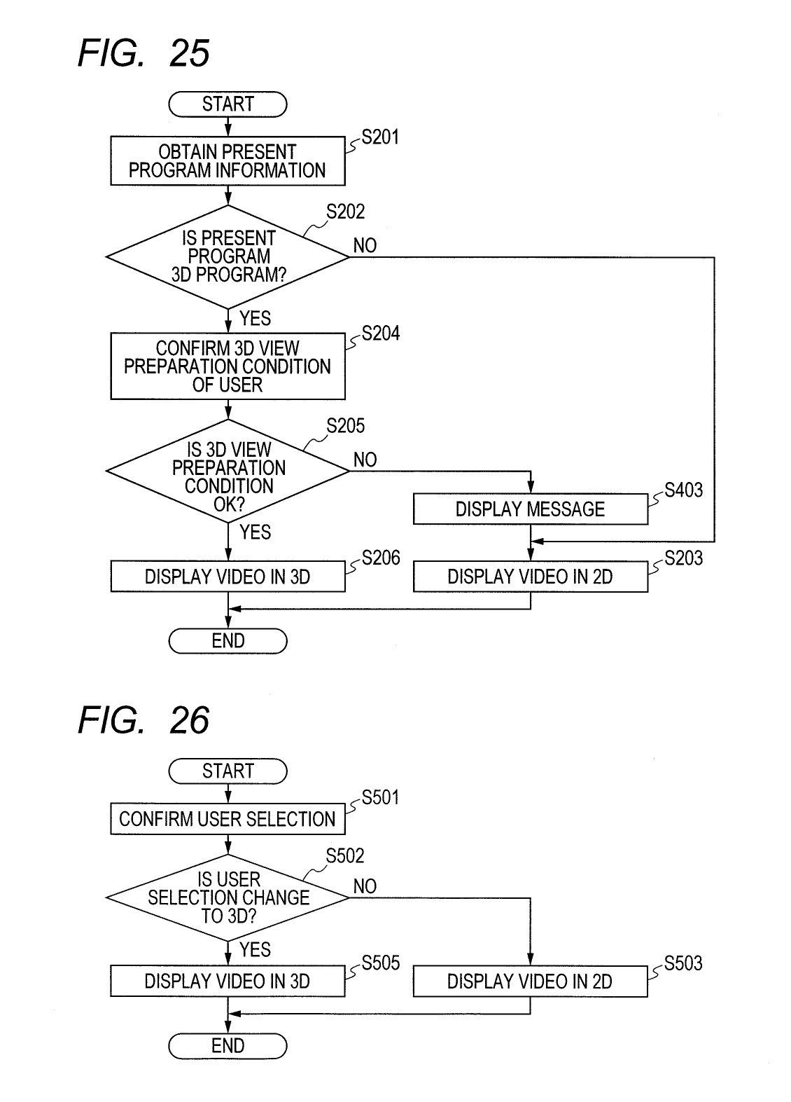

Next, explanation will be given on an example of displaying the 3D video if the 3D view preparation condition of the user is “OK”, or displaying the message for prompting the 3D view preparation if not “OK”. The processing flow within the system controller unit 51 in this case will be shown in FIG. 25.

This processing flow is executed when the program information of the present program is changed, such as, the tuning or the power ON, etc., for example. The processing flow for determining the 3D view preparation condition is determined (i.e., the steps S201, S202, S204 and S205) is similar to that shown in FIG. 11 or 16.

Thereafter, in case where the 3D view preparation condition is not “OK” (“no” in the step S205), a notice is given to the user, as shown in FIG. 16, indicating that the 3D program starts, and a message is displayed for prompting the user to select the operation thereafter (S403), and further the video is changed to the 2D display (S203); thereby the process is ended.

As an example of the method for determining the user selection on the screen display shown in FIG. 16, when the user pushes down the <3D> button of the remote controller while operating the remote controller, or when she/he pushes down the <OK> button of the remote controller while fitting the cursor to “OK/3D” on the screen, the user selection is determined to be the “change to 3D”.

Or, when the user pushes down the <cancel> button or the <return> button of the remote controller, or when she/he pushes down the <OK> button of the remote controller, while fitting the cursor to “cancel” on the screen, the user selection is determined to be the “other than change to 3D”.

Other than this, when such an operation is done that the 3D view preparation condition mentioned above comes to “OK” (for example, put on of the 3D glasses), the user selection may be determined to be “change to 3D”.

The processing flow to be executed within the system controller 51 after the user has done the selection will be shown in FIG. 26. The system controller 51 obtains from the user instruction receiver unit 52 what the user selects among the menu display (S501). In case where the selection by the user is not the “change to 3D” (“no” in the step S502), the video is displayed in the 2D (S503), and the process is ended. In case the selection by the user is the “change to 3D” (“yes” in the step S502), the video is displayed in the 3D (S505), and the process is ended.

In this manner, as a result that the user changes the program through the tuning, etc., in case where the present program is the 3D program, the 3D video is displayed when the 3D view preparation condition of the user is “OK”, while where not “OK”, the message is displayed while displaying the video of the 2D, and thereby the can change it into the 3D video, easily, after she/he completes the 3D view preparation. Also, the user can notice that the present program is the 3D program, easily, and also if the 3D view preparation condition of the user is already “OK”, she/he can view the 3D program, instantaneously, without unnecessary changing to the 2D or displaying the message.

With this example, since the recording apparatus is not applied therein, it is useful when the recoding apparatus cannot be used (for example, where a resource is in shortage during the time when recording other program, or where the recording apparatus is not equipped with). For example, in the processing flow, which was explained by referring to FIG. 15 or FIG. 20, in particular, when the recording operation cannot be done, it is preferable to carry out this example.

With the embodiment explained in the above, it is possible for the user to view/listen the 3D program under a good condition, i.e., in particular, in relation to the beginning part of the 3D program, the user can complete the 3D view preparation in advance, or she/he can display the video, again, after the user completes the preparation for viewing the 3D program with using the recording/reproducing function if she/he cannot prepare in time for the starting of the 3D program, etc. Also, it is possible to increase the convenience for the user; since the display method is automatically changed into the display method, which is seemed to be desirable for the user (i.e., displaying the 3D video by 3D displaying method when she/he wishes to view the 3D video by 3D view or displaying the 3D video by 2D displaying method when she/he wishes to view the 3D video by 2D view). Also, the similar effects can be expected, when she/he changes the program to the 3D program through the tuning, or when she/he starts the reproducing of the 3D program, which is recorded.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A video processing apparatus, comprising:
an input unit, to which video information is inputted;
a decoder unit, which is configured to decode the video information inputted to said input unit; and
an output unit, which is configured to output the video information decoded within said decoder unit, wherein
a message indicting that there is a schedule for outputting 3D video information from said output unit, in case where the video information to be inputted to said input unit after elapsing a predetermined time is the 3D video information.

2. The video processing apparatus, as described in the claim 1, wherein
the message indicting that there is a schedule for outputting said 3D video information includes a time-period until when an output of said 3D video information will be started, or a time when said 3D video information will be outputted.

3. The video processing apparatus, as described in the claim 1, wherein
the message indicting that there is a schedule for outputting said 3D video information includes a 3D video to be used for confirmation of availability of viewing of the 3D video.

4. The video processing apparatus, as described in the claim 1, wherein
said output unit exchanges to output said 3D video information as the 3D video information or to output as a 2D video information depending on a condition of a user.

5. A video processing apparatus, comprising:
an input unit, to which video information is inputted;
a recording unit, which is configured to record the video information inputted to said input unit onto a recording medium;
a decoder unit, which is configured to decode the video information inputted to said input unit or the video information recorded in said recording unit; and
an output unit, which is configured to output the video information decoded within said decoder unit, wherein
said recording unit starts recording of said 3D video information, when the 3D video information is inputted to said input unit in case where a user is not in a condition of being able to view the 3D video.

6. The video processing apparatus, as described in the claim 5, wherein
any one of an output of the 3D video information recorded in said recording unit, an output of the 3D video information inputted to said input unit as the 3D video information, and an output of the 3D video information inputted to said input unit as 2D video information is outputted, depending on an instruction made by the user, after starting the recording of the 3D video information in said recording unit.

7. The video processing apparatus, as described in the claim 5, wherein
said output unit outputs a predetermined picture during time from when starting the recording of the 3D video information in said recording unit until when outputting said 3D video information recorded.

8. A video processing apparatus, comprising:
an input unit, to which video information is inputted;
a decoder unit, which is configured to decode the video information inputted to said input unit; and
an output unit, which is configured to output the video information decoded within said decoder unit, wherein
the video information outputted from said output unit is 3D video information, and a message for prompting a user to be in a condition of being able to view the 3D video from said output unit, if the user is not in the condition of being able to view the 3D video.

9. A video processing apparatus, comprising:
an input unit, to which video information is inputted;
a decoder unit, which is configured to decode the video information inputted to said input unit; and
an output unit, which is configured to output the video information decoded within said decoder unit, wherein
the video information outputted from said output unit is 3D video information, and an output of the 3D video information from said output unit is stopped, temporally, when the user is not in the condition of being able to view the 3D video.
